(19) United States
(12) Patent Application Publication
(10) Pub. No.: US 2007/0002512 A1
(43) Pub. Date: Jan. 4, 2007

(54) Circuit arrangement for overvoltage detection and method for operating circuit arrangement

(75) Inventor: Hubert Schonenberger, Muenchen (DE)

Correspondence Address: MILES & STOCKBRIDGE PC, 1751 PINNACLE DRIVE, SUITE 500, MCLEAN, VA, 22102-3833, US

(73) Assignee: Puls GmbH, Munchen (DE)

(21) Appl. No.: 11/296,703

(22) Filed: Dec. 8, 2005

(30) Foreign Application Priority Data
Dec. 9, 2004 (DE) DE10.2204059455.4

(51) Int. Cl. H02H 9/06

(52) U.S. Cl. 361/118

(57) ABSTRACT

A circuit arrangement for overvoltage detection is disclosed, which has an input, a filter, a transient detection, and an output. The filter and the transient detection are connected to the input; the output is connected to the filter and the transient detection. The circuit arrangement provides overvoltage problems. A method for operating the circuit arrangement is also disclosed.

The invention relates to a circuit arrangement for overvoltage detection and a method for operating the circuit arrangement.

Particularly for supplying electrical networks, it is necessary to protect circuits, devices, or power-consuming components from overvoltages, in particular overvoltage pulses. Such a pulse is defined, for example, in the standard EN61000-4-5, which has a rise time of 1.2 □s and a half value time of 50 □s and can occur, for example, when lightning strikes. The standard VDE0160W2 describes another known pulse with a peak voltage of 747 volts (rise time 100 μs, half value time 1.3 ms), which, as a pure voltage pulse, supplies a (theoretically infinitely) high current.

There are also other known power system malfunctions that can lead to predominantly temporary voltage/current spikes in an electric system.

The object of the present invention is to effectively and efficiently protect an electrical circuit, an electrical power-consuming component, and or an electrical device from overvoltages.

This object is attained according to the defining characteristics of the independent claims. Modifications of the invention ensue from the dependent claims.

To begin with, it should be noted that the term overvoltage is intended herein to apply to all forms of voltages greater than a predetermined supply voltage, in particular a line voltage, and all forms of voltage spikes. In particular, the term “transient” below applies to all types of chronologically limited overvoltages that deviate from the target values of the electrical supply voltage. It should additionally be noted that an overvoltage can also stem from a current spike.

The object of the invention is attained by a circuit arrangement for overvoltage detection that has an input, a filter, a transient detection, and an output. The filter and the transient detection are connected to the input; the output is connected to the filter and the transient detection.

The term “transient detection” particularly applies to a unit whose function is to detect when the input voltage exceeds a predetermined threshold and to relay information regarding this excess.

The transient detection (“transient detection unit”) advantageously permits early detection of an overvoltage pulse and makes it possible to protect the output from the overvoltage pulse directly through intervention of the transient detection or through an additional transient suppression unit (“transient suppression”) or transient cancellation unit. The quick, dynamic, and effective detection of the overvoltage pulse permits consequent savings with regard to how voltage-proof the subsequent components in the output have to be, e.g. power semiconductors with low breakdown voltages, and permits savings with regard to loss-encumbered components, e.g. a large electrolytic capacitance at the input of the circuit arrangement.

In a modification, the filter is a low-pass filter.

It is also possible for the output of the filter to be connected to the transient detection.

In another modification, a line voltage is supplied to the input.

In a further modification, the filter includes at least one inductance. In this case, the transient detection can evaluate a signal before the at least one inductance and/or after the at least one inductance. It is particularly advantageous for the transient detection to evaluate the voltage only before the filter because this permits early detection of the overvoltage pulse. It is optionally possible for the transient detection to also evaluate the voltage after the filter.

In another modification, the transient detection includes at least one comparator.

In one modification, the output includes a circuit. In particular, this is a circuit that should be protected from the overvoltage pulse. Preferably, this circuit can include a control circuit, in particular equipped with a pulse-to-width modulation and/or a driver stage.

In another modification, the input includes a rectifier circuit, e.g. a bridge rectifier.

In another modification, a transient suppression is provided, which is connected between the filter and the output and is also connected to the transient detection. In particular, this transient suppression can include a switch, preferably an electronic switch, e.g. at least one transistor, at least one MOSFET, or at least one IGBT. It is also possible for the transient suppression to be provided with combinations of these switch types.

In a modification, the switch of the transient suppression can be triggered by means of a driver stage. In particular, the switch can be triggered in a potential-free manner.

Preferably, the circuit arrangement can be used to protect any kind of electrical circuit or device from overvoltage pulses. In particular, the circuit arrangement can be used in a power supply, a power pack, or a switched mode power supply.

The use of the circuit arrangement is not limited to public power grids; it is also possible to connect the input of the circuit arrangement to electrical supply networks operated separately from public power grids and to connect it to intermediate circuit voltages inside devices.

The object of the invention is also attained by means of a method for regulating or triggering the above-described circuit arrangement.

Exemplary embodiments of the invention will be explained below in conjunction with the drawings.

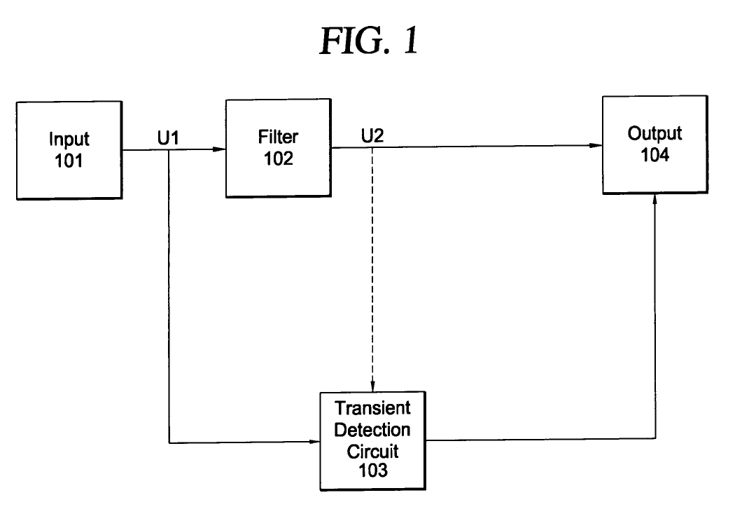

FIG. 1 is a block circuit diagram of a circuit arrangement for overvoltage detection;

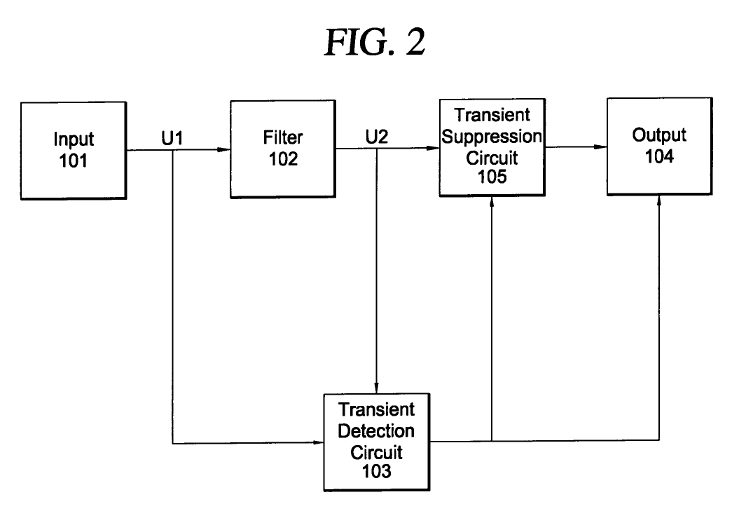

FIG. 2 is a block circuit diagram of a circuit arrangement for overvoltage detection with a transient suppression;

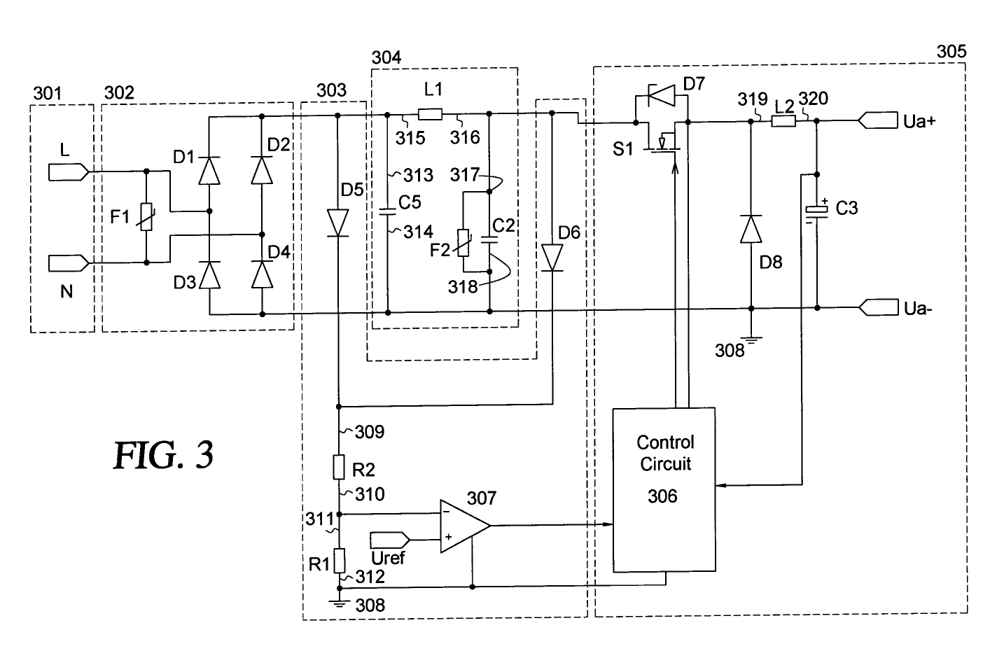

FIG. 3 is a circuit arrangement for overvoltage detection;

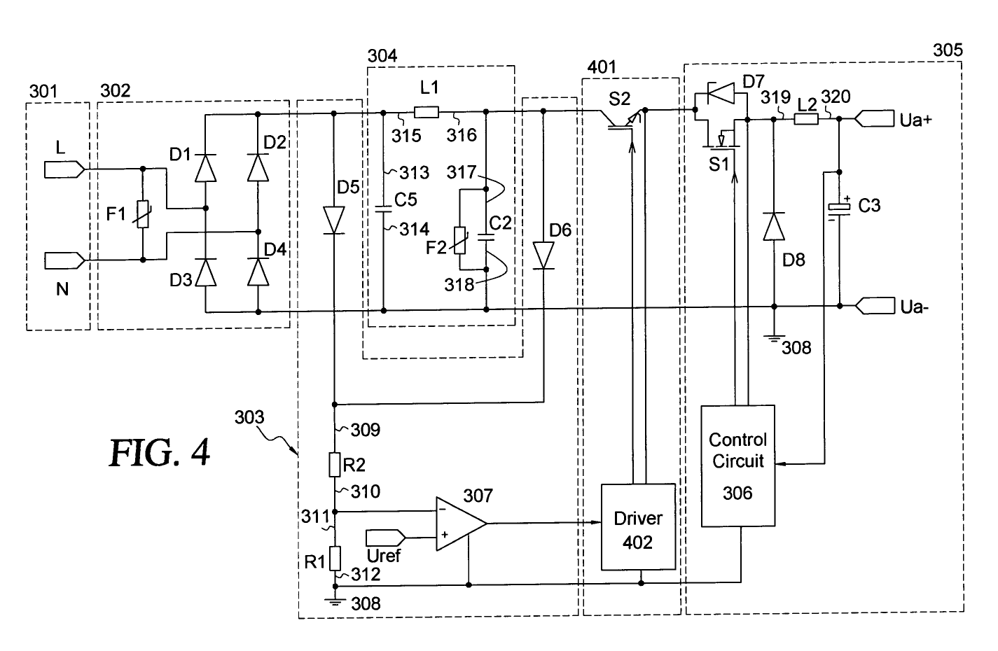

FIG. 4 is a circuit arrangement for overvoltage detection with a transient suppression;

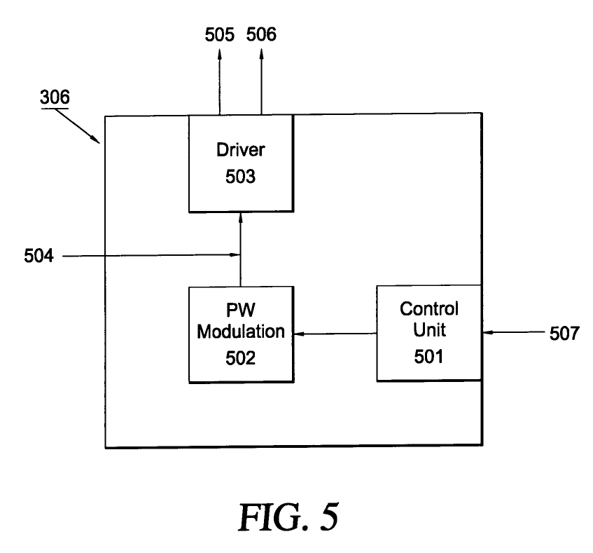

FIG. 5 is a detailed view of the control circuit 306; and

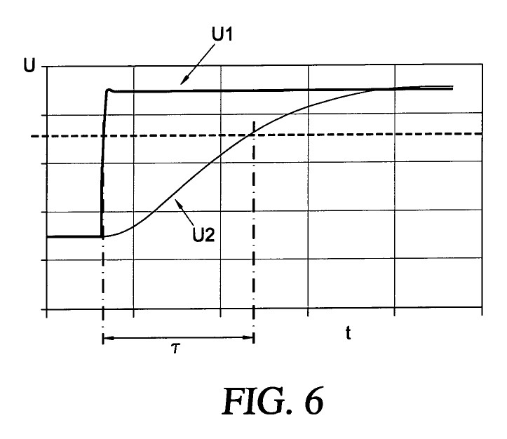

FIG. 6 is a voltage graph to illustrate the time delay of the filter.

FIG. 1 is a block circuit diagram of a circuit arrangement for overvoltage detection. An input 101 is connected to a filter 102. After the filter 102, the signal is supplied to an output 104 and optionally, (indicated by the dashed line in FIG. 1), to a transient detection 103. The input side of the transient detection 103 is connected to the input 101 and optionally, to the above-mentioned filter 102, while its output side is connected to the output 104.

In addition to the arrangement shown in FIG. 1, in FIG. 2, a transient suppression unit (“transient suppression”) 105 is provided, which is connected between the filter 102 and the output 104, i.e. the input side of the transient suppression 105 is connected to the filter 102 and the transient detection 103, while its output side is connected to the output 104.

In FIGS. 1 and 2, the power paths are emphasized by means of thicker lines and the data paths are indicated by thinner lines.

FIG. 3 shows a circuit arrangement for overvoltage detection. The circuit arrangement includes an input 301, a rectifier 302, a low-pass filter 304, a transient detection 303, and an output 305 with a circuit to be protected from overvoltage pulses.

The input 301 includes two connections L and N.

The rectifier 302 includes a varistor F1 and four diodes D1, D2, D3, and D4. The varistor F1 is connected in parallel with the connections L and N of the input 301. The cathode of the diode D1 is connected to the cathode of the diode D2, the anode of the diode D1 is connected to the cathode of the diode D3 and to the connection L, the anode of the diode D2 is connected to the cathode of the diode D4 and to the connection N, and the anode of the diode D3 is connected to the anode of the diode D4.

The transient detection 303 includes diodes D5 and D6, resistors R2 (with connections 309 and 310) and R1 (with connections 311 and 312), a comparator 307, a reference voltage Uref, and a ground potential 308. The anode of the diode D5 is connected to the cathode of the diode D2 (and the cathode of the diode D1). The cathode of the diode D5 is connected to the cathode of the diode D6 and to the connection 309 of the resistor R2. The connection 310 of the resistor R2 is connected to the negative input of the comparator 307 and to the connection 311 of the resistor R1. The remaining connection 312 of the resistor R1 is connected to the ground potential 308 and to the corresponding ground connection of the comparator 307. The positive input of the comparator 307 is connected to the reference voltage Uref.

The low-pass filter 304 includes an inductance L1 (with connections 315 and 316), capacitors C2 (with connections 317 and 318) and C5 (with connections 314 and 314), and a varistor F2. The connection 313 of the capacitor C5 is connected to the connection 315 of the inductance L1 and to the anode of the diode D5 (and therefore also to the cathode of the diode D2 and the cathode of the diode D1). The connection 314 of the capacitor C5 is connected to the anode of the diode D3 (and to the anode of the diode D4). The varistor F2 is connected in parallel to the capacitor C2, whose connection 317 is connected to the connection 316 of the inductance L1 and to the anode of the diode D6. The connection 318 of the capacitor C2 is connected to the connection 314 of the capacitor C5.

The output 305 includes a circuit with a control circuit 306, an n-channel MOSFET embodied in the form of a switch S1 with an internal parasitic Zener diode D7, a diode D8, an inductance L2 (with the connections 319 and 320), an electrolytic capacitor C3, and the connections Ua+ and Ua−.

As an input signal, the control circuit 306 receives the output signal of the comparator 307 and the voltage 320 to be regulated. In addition, the control circuit 306 is connected to the ground potential 308. The control circuit 306 is also connected to the source connection and the gate connection of the MOSFET S1.

The drain connection of the MOSFET Si is connected to the anode of the diode D6 (and therefore also to the connection 316 of the inductance L1). The parasitic Zener diode D7 is internally connected between the drain connection and the source connection of the MOSFET S1, the cathode of the Zener diode D7 being connected to the drain of the MOSFET S1. The source connection of the MOSFET Si is in turn connected to the cathode of the diode D8 and to the connection 319 of the inductance L2. The remaining connection 320 of the inductance L2 is connected to the connection Ua+ and to the positive pole of the electrolytic capacitor C3. In addition, this connection 320 is connected to the control circuit 306 as an input signal.

The negative pole of the electrolytic converter C3 is connected to the connection Ua−, the anode of the diode D8, the ground potential 308, and, among other things, the connection 318 of the capacitor C2 (and is thus also connected to the connection 314 of the capacitor C5, the anode of the diode D4, and the anode of the diode D3).

In addition to what is contained in the arrangement shown in FIG. 3, FIG. 4 contains a transient suppression 401. This transient suppression 401 is connected between the filter 304, the transient detection 303, and the output 305. Otherwise, the circuit arrangement shown in FIG. 4 corresponds to the one shown in FIG. 3.

The transient suppression 401 includes a driver 402 and a switch S2, which is depicted here in the form of an IGBT. The gate and emitter of the switch S2 are connected to the output of the driver 402. The driver 402 receives an input signal from the output signal of the comparator 307. In addition, the driver 402 is connected to the ground potential 308. Preferably, the input and output of the driver 402 are galvanically separated from each other, which permits a transmission of the “floating” reference potential of the switch S2 with the aid of an impedance conversion with the corresponding current amplification.

The collector of the switch S2 is connected to the anode of the diode D6 (and to the connection 316 of the inductance L1 and the connection 317 of the capacitor C2). The emitter of the switch S2 is also connected to the drain connection of the MOSFET S1 (and the cathode of D7).

Consequently, by contrast with the circuit arrangement from FIG. 3, in FIG. 4, the filter 304 and the transient detection 303 are no longer directly connected to the output 305.

FIG. 5 shows the interior structure of the control circuit 306 (with inputs 504, 507 and outputs 505, 506) from FIGS. 3 and 4, with a control unit 501, a pulse-to-width modulation 502, and a driver 503. The input side of the control unit 501 (see input 507) is connected to the connection 320 of the inductance L2 (see FIGS. 3 and 4), the output of the control unit 501 is connected to the input of the pulse-to-width modulation 502, and the output of the pulse-to-width modulation 502 is connected to the input of the driver 503. The output side of the driver 503 (see outputs 505 and 506) is connected to the gate connection and to the source connection of the MOSFET S1. In FIG. 3, but not FIG. 4, the input 504 of the control circuit 306 is supplied with the output signal of the comparator 307 and is connected between the pulse-to-width modulation 502 and the driver 503.

Operation of the Circuit:

a. Function Description of the Circuit Arrangement According to FIG. 3:

Preferably, the input 301 is supplied with an AC line voltage that the rectifier 302 rectifies into a pulsating DC voltage. The varistor F1 first eliminates overvoltages, i.e. once a predetermined voltage in the connections L and N is reached, the varistor F1 is switched into the low-impedance state, thus preventing a further rise in voltage.

The varistor F1 is usually designed to have a voltage range that is limited toward the bottom, i.e. the above-explained effect comes into play only after a sufficiently high voltage has been reached. It is suitable if the overvoltage above which the varistor F1 is switched into the low-impedance state is greater than approx. 750 volts. On the one hand, this makes it possible to effectively reduce the overvoltage pulse (on the order of 2000 volts) described in the standard EN61000-4-5 mentioned at the beginning. But a pulse according to the standard VDE0160W2 with an intensity of approx. 750 volts can pass the varistor F1 unhindered. Because of the energy-containing transient in the VDE0160W2 pulse, the varistor F1 would be destroyed if it were already switched to the low-impedance state at an intensity of 750 volts.

Given this state of affairs, the varistor F1 is preferably suitable for filtering very high voltages, but voltage pulses in a range of up to approximately 800 volts are often harmful to the subsequent circuit in the output 104 and must be effectively suppressed independently of the varistor F1.

The transient detection 303 is connected both before and after the filter 304. The two diodes D5 and D6 form a logical “OR connection” for possible overvoltages before and after the filter 304. A voltage divider comprised of the resistors R2 and R1 supplies these overvoltages to the comparator 307, where they are compared to the reference voltage Uref.

The reference voltage Uref must be determined so that (divided by the resistor R1 and the resistor R2), it corresponds to the threshold voltage to be detected at the connection 315 of the inductance L1 or at the connection 316 of the inductance L1. It is also possible for the reference voltage Uref to be produced using a Zener diode or a reference voltage diode.

If the voltage at the positive input of the comparator 307 is greater than the reference voltage Uref, then the comparator 307 switches into the conductive state, i.e. a signal is sent to the control circuit 306 indicating that an overvoltage pulse is present. As a result, the control circuit 306 closes the switch S1, which can carry energy—possibly present in the form of current in the inductance L2—away via the freewheeling diode D8 before the overvoltage pulse (the transient) reaches the switch S1. A subsequent avalanche mode (breakdown or Zener breakdown mode) of the switch S1 via the (internal) Zener diode D7—which is caused by the breakdown voltage being exceeded between the drain and source of the switch S1—is, however, not critical to the switch S1 since the inductance L2 is without current in the meantime and is the component that determines the avalanche current.

The control circuit 306 includes the control unit 501, which evaluates the voltage at the connection 320 of the inductance L2 (supplied via the connection 507) and transmits a control signal to the pulse-to-width modulation (PWM) 502. The driver 503 conveys the clock signals generated during the pulse-to-width modulation 502 to the MOSFET S1 separately from the potential.

If the transient detection 303 detects an overvoltage pulse at the connection 315 of the inductance L1 or at the connection 316 of the inductance L1, then the output (open collector) of the comparator 307 switches to the logical “0” setting (see input signal 504) and consequently suppresses the clock signal at the input of the driver 503.

The early detection of overvoltage pulses is achieved by taking advantage of the group run time □ (see FIG. 6) of the filter 102, in that in addition to a voltage U2 after the filter 102, a voltage U1 before the filter 102 is also consulted as a criterion (also see FIGS. 1 and 2). The information is present in the voltage U1 first, i.e. in advance by the amount of the run time delay r. This makes it possible to take the necessary steps to punctually counteract the overvoltage pulse, e.g. the switch S2 can be actively opened in order to block the overvoltage pulse and prevent it from ever reaching the output 104 or 305. Alternatively (as shown in the circuit of the output 305), a converter can also be switched into an energetic state, which is not critical for an overvoltage pulse. In the latter case, it is possible, for example, to punctually convey the energy out of the inductance L2 so that the inductance L2 is in a virtually currentless state when the overvoltage pulse arrives in order to limit the avalanche current of the MOSFET S1 and thus prevent it from being destroyed.

b. Function description of the circuit arrangement according to FIG. 4:

By contrast with the above-described operation of the circuit arrangement according to FIG. 3, the circuit arrangement according to FIG. 4 functions similarly, but the overvoltage pulse is actively blocked by means of the transient suppression 401 in that the output of the comparator 307 is supplied to the driver 402 and in response, the driver 402 triggers the switch S2, i.e. disconnects the switch S2, thus preventing the overvoltage pulse from reaching the output 305. In particular, the driver 402 can be embodied in the form of a potential-free triggering of the switch S2 so that the switch S2 can be switched independent of a reference potential.

It is also conceivable to connect terminal modifications in parallel with the output in order to nullify transients. When the overvoltage pulse is detected, a series circuit comprised of an additional switch and an additional varistor (with a lower terminal voltage) can activate (close) the switch and the overvoltage pulse can consequently be nullified with the aid of the thus-activated varistor. If no overvoltage pulse is detected, i.e. during normal operation, the switch is open and the varistor is inactive.

1. A circuit arrangement for overvoltage detection, including
an input (101),
a filter (102) connected to the input (101),
a transient detection circuit (103) that is connected to the input (101), and
an output (104) connected to the filter (102) and the transient detection circuit (103).

2. The circuit arrangement according to claim 1 wherein the filter (102) is a low-pass filter.

3. The circuit arrangement according to claim 2 wherein the input (101) is connected to a line supply voltage.

4. The circuit arrangement according to claim 1 in which the filter (102) includes at least one inductance (L1).

5. The circuit arrangement according to claim 1 in which the filter (102) is connected to the transient detection (103).

6. The circuit arrangement according to claim 4 wherein the transient detection circuit (103) evaluates a first signal before applied to the at least one inductance (L1) and/or a second signal after at the output from the least one inductance (L1).

7. The circuit arrangement according to claim 1 wherein the transient detection circuit (103) includes at least one comparator (307).

8. The circuit arrangement according to claim 1 wherein the output (104) includes a is connected to an operative circuit (305).

9. The circuit arrangement according to claim 8, wherein the operative circuit (305) includes a control circuit (306).

10. The circuit arrangement according to claim 9, in which the control circuit (306) includes pulse-to-width modulation and/or a driver stage.

11. The circuit arrangement according to claim 1 wherein the input (101) is connected to a rectifier circuit (302).

12. The circuit arrangement according to claim 1 wherein a transient suppression circuit (105) is connected between the filter (102) and the output (104) and to the transient detection circuit (103).

13. The circuit arrangement according to claim 12, wherein the transient suppression circuit (105) includes a switch (S2).

14. The circuit arrangement according to claim 13, wherein the switch (S2) is an electronic switch having at least one bipolar transistor, or at least one MOSFET.

15. The circuit arrangement according to claim 13 wherein the switch (S2) is triggered by means of a driver stage (402).

16. The circuit arrangement according to claim 13 wherein the switch (S2) is triggered in a potential-free manner.

17. (canceled)

18. (canceled)

19. The circuit arrangement according to claim 13 wherein the switch is an electronic switch having at least one IGBT.

20. The circuit arrangement according to claim 13 wherein the switch is an electronic switch having at least one bipolar transistor, at least one of a MOSFET or IGBT and a driven stage (402).
